(19) United States
(12) Patent Application Publication
(10) Pub. No.: US 2023/0141426 A1
(43) Pub. Date: May 11, 2023

(54) CUTTING IMPLEMENT

(71) Applicant: KYOCERA CORPORATION, Kyoto-shi, Kyoto (JP)

(72) Inventor: Takanori NISHIHARA, Takatsuki-shi, Osaka (JP)

(21) Appl. No.: 17/912,256

(22) PCT Filed: Mar. 11, 2021
(86) PCT No.: PCT/JP2021/009876

§ 371 Date: Sep. 16, 2022

(30) Foreign Application Priority Data
Mar. 19, 2020 (JP) 2020-049101

(51) Int. Cl. B26B 9/02; B26B 3/00

(52) U.S. Cl. CPC B26B 9/02; B26B 3/00

(57) ABSTRACT

A cutting implement includes a blade body including a base portion and a blade edge portion disposed along an end portion of the base portion. The base portion is made of a hollow body formed by sintering a first constituent material powder. The blade edge portion is made of a solid body formed by sintering a second constituent material powder. A reinforcing wall is provided inside the hollow body at at least a cutting implement tip portion of the base portion.

### TECHNICAL FIELD

The present disclosure relates to a cutting implement such as a kitchen knife.

### BACKGROUND OF INVENTION

Traditionally, kitchen knives made of a material that contains a metal material as a main component have been used. Among these, in recent years, a kitchen knife made of stainless steel that contains nickel and chromium as a component is widely used (see Patent Document 1). Also known is a ceramic kitchen knife that contains zirconium oxide as a main component (see Patent Document 2).

### CITATION LIST

### Patent Literature

Patent Document 1: JP 2000-189682 A
Patent Document 2: WO 2016/190343

### SUMMARY

### Problem to be Solved

In the present disclosure, a cutting implement includes a blade body. The blade body includes a base portion and a blade edge portion disposed along an end portion of the base portion. The base portion is made of a hollow body. The blade edge portion is made of a solid body. A reinforcing wall is provided inside the hollow body at at least a cutting implement tip portion of the base portion.

### BRIEF DESCRIPTION OF THE DRAWINGS

FIG. 1 is a side view illustrating a state in which a handle is attached to a cutting implement according to an embodiment of the present disclosure.

FIG. 2 is a cross-sectional view of the cutting implement illustrated in FIG. 1 as viewed from a side face direction.

FIG. 3 is a cross-sectional view of the cutting implement illustrated in FIG. 1 taken along the line X-X.

FIGS. 4A and 4B are a side view and a plan view of a cutting implement according to another embodiment of the present disclosure, respectively.

### DESCRIPTION OF EMBODIMENTS

Hereinafter, a cutting implement according to an embodiment of the present disclosure will be described with reference to drawings. Note that the drawings used in the following description are schematic. The dimensions, proportions, and the like in the drawings do not necessarily coincide with the actual values.

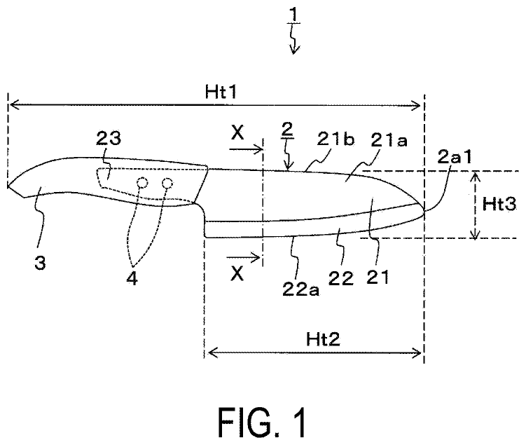

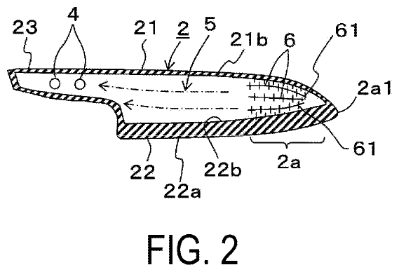

As illustrated in FIGS. 1 and 2, a cutting implement 1 of the present disclosure includes a blade body 2 and a handle 3 connected to the blade body 2. The blade body 2 includes a base portion 21 and a blade edge portion 22 disposed along an end portion of the base portion 21.

The shape and size of the blade body 2 are set in accordance with the applications of the cutting implement 1. If the cutting implement 1 is a kitchen knife, examples of the shape of the blade body 2 include shapes of a Japanese kitchen knife such as a kitchen knife for cutting fish, a santoku knife, and a sashimi knife, a Western knife such as a butcher knife, or a Chinese knife. If the cutting implement 1 is for applications other than a kitchen knife, such as a knife for a surgical instrument, the cutting implement 1 may have any shape as long as the shape is suited to its application.

The handle 3 connected to the blade body 2 is to be gripped by a hand when a person utilizes the cutting implement 1. As in the case of the blade body 2, the shape and size of the handle 3 are set in accordance with the applications of the cutting implement 1. The handle 3 contains wood, resin, ceramic, or a metal material.

The blade body 2 and the handle 3 may be formed integrally or separately. In the present embodiment, the blade body 2 and the handle 3 are separately formed. A part of the blade body 2, that is, a handle portion 23 is inserted into the handle 3, and is fixed to the handle 3 at the insertion portion. The handle portion 23 may also be referred to as a tang.

The cutting implement 1 may have any dimensions. For reference purposes, examples of the dimensions of the cutting implement 1 will be given. The total length Ht1 illustrated in FIG. 1 may be set to not less than 5 cm and not more than 40 cm. The length Ht3 in the width direction orthogonal to the total length Ht1 of the blade body 2 may be set to not less than 10 mm and not more than 150 mm. The blade length (the length of the portion with the blade) Ht2 of the blade body 2 may be set as appropriate in accordance with the application. When used as a typical kitchen knife or the like, the blade length Ht2 may be set to not less than 5 cm and not more than 35 cm, for example.

The thickness of the blade body 2 at the thickest portion may be set to not less than 1 mm and not more than 5 mm, for example. The length and thickness of the handle 3 can be set as appropriate. For example, the thickness of the handle 3 may be set to be not less than 5 mm and not more than 3 cm.

The base portion 21 of the blade body 2 is formed integrally with the handle portion 23. A hole 4 is provided in the handle portion 23. Only one hole 4 may be provided, or a plurality of holes 4 may be provided. The hole 4 is used for fixing the blade body 2 to the handle 3. As will be described later, however, the hole 4 also functions as a discharge hole for discharging powders within the cutting implement 1 during manufacturing of the cutting implement 1. The hole 4 is formed in a circular shape having a radius of not less than 0.5 mm and not more than 3 mm, for example. Note that the handle portion 23 may be used as a handle without the handle 3 being used.

As illustrated in FIG. 2, the base portion 21 is a hollow body formed by sintering or melting a first constituent material powder, and the blade edge portion 22 is a solid body formed by sintering or melting a second constituent material powder. As will be described later, such a base portion 21 and such a blade edge portion 22 can be manufactured with a 3D printer, for example. The handle portion 23 is also a hollow body as in the case of the base portion 21. The base portion 21 and the handle portion 23 form hollow bodies in communication with each other. Accordingly, the hole 4 formed in the handle portion 23 is in communication with the inside of the hollow body (the internal space of the hollow body) in the base portion 21.

Note that in the following description, the base portion 21 includes the handle portion 23.

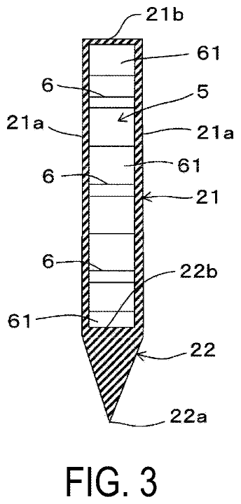

In the present disclosure, the blade edge portion 22 refers to a region of a solid body including a cutting edge ridge portion 22a. As illustrated in FIG. 3, the base portion 21 includes both side faces 21a and 21a and a spine 21b, and the hollow body includes a space 5 formed by a rear face portion 22b of the blade edge portion 22, the both side faces 21a and 21a, and the spine 21b.

As illustrated in FIG. 2, a plurality of reinforcing walls 6 are provided inside the hollow body at a cutting implement tip portion 2a. As illustrated in FIG. 3, the reinforcing wall 6 is provided between the both side faces 21a and 21a. The reinforcing wall 6 is used to reinforce the base portion 21 that is a hollow body. Here, the cutting implement tip portion 2a refers to a region accounting for not less than 20% and not more than 40% of to the total length of the base portion 21 excepting the handle portion 23.

An end of the reinforcing wall 6 may be connected to the inner surface of a cutting implement tip 2a1, and need not be connected to the inner surface of the cutting implement tip 2a1. FIG. 2 illustrates a state in which the end of the reinforcing wall 6 is not connected to the inner surface of the cutting implement tip 2a1. The reinforcing wall 6 is provided at the cutting implement tip portion 2a because the cutting implement tip portion 2a is the site that is subjected to the impact force the most during the use of the cutting implement 1. Therefore, the reinforcing wall 6 may be formed not only at the cutting implement tip portion 2a but also across the total length of the base portion 21 or the total length of the base portion 21 not including the handle portion 23.

As illustrated in FIG. 2, the plurality of reinforcing walls 6 are formed in a lattice shape (in a state in which the reinforcing walls 6 are disposed side by side with each other). At this time, the reinforcing walls 6 may be parallel to each other or non-parallel to each other. In the present embodiment, the reinforcing walls 6 are formed in a divergent shape from the cutting implement tip 2a1 so as to run along the shape of the base portion 21 such that the farther away from the cutting implement tip 2a1, the greater the spacing between each pair of adjacent reinforcing walls 6.

A plurality of vanes 61 orthogonal to the longitudinal direction of the reinforcing wall 6 are formed at predetermined intervals at the reinforcing wall 6 at the cutting implement tip portion 2a, and at the inner surfaces of the rear face portion 22b of the blade edge portion and the spine 21b of the base portion 21. The vane 61 is provided between the both side faces 21a and 21a as in the case of the reinforcing wall 6. The plurality of vanes 61 formed at the reinforcing wall 6 provide the cutting implement tip portion 2a with further improved reinforcing effect. The vane 61 is formed simultaneously with the reinforcing wall 6.

The hollow body that serves as the base portion 21 is formed by sintering or melting the first constituent material powder. The solid body that serves as the blade edge portion 22 is formed by sintering or melting the second constituent material powder.

For the first constituent material powder and the second constituent material powder, the same or different powder that is sinterable or meltable metal powder or ceramic material powder is used.
Examples of usable metal powder include ferritic stainless steel, austenitic stainless steel, nickel-based alloy such as Inconel (trade name), titanium alloy, nickel-cobalt alloy, cobalt alloy, cobalt-chromium-tungsten alloy such as Stellite (trade name), and cobalt-chromium-molybdenum alloy (CCM alloy). Examples of usable ceramic powder include oxide ceramics such as zirconium oxide (zirconia) or carbide ceramics such as tungsten carbide, titanium carbide, and vanadium carbide.

To integrally and firmly bond together the base portion 21 and the blade edge portion 22, the same material is preferably used for the first constituent material powder and the second constituent material powder. However, the first constituent material powder and the second constituent material powder may be different from each other as long as the base portion 21 and the blade edge portion 22 can be firmly bonded together.

The particle sizes of the first constituent material powder and the second constituent material powder can be determined as appropriate depending on the material or the like. Typically, the particle sizes of the first constituent material powder and the second constituent material powder are preferably not less than 40 μm and not more than 120 μm. For example, the particle sizes can be adjusted by a mechanical method such as ball milling and sifting through sieves, or a spraying method such as a gas atomizing method or a water atomizing method.

A method for manufacturing the cutting implement of the present disclosure will be described. To sinter the first constituent material powder to form a hollow body and to sinter the second constituent material powder to form a solid body, a powder sintering and additive manufacturing method is preferably employed, for example. To that end, a powder sintering 3D printer can be used.

Examples of the powder sintering and additive manufacturing method include selective laser sintering (SLS) and direct metal laser sintering (DMLS). Apart from the above, selective laser melting (SLM), electron beam melting (EBM), laser engineered net shaping, laser metal deposition (LMD), and the like can also be employed.

Selective laser sintering is a method in which material powders are spread over a shaping stage, and the material powders are irradiated with a laser beam such as that of a carbon dioxide gas laser to perform shaping. Shaping is performed while the material powder adjusted to a predetermined particle size is supplied from a powder supply unit onto the shaping stage. Upon completion of the shaping of one layer, the shaping stage is lowered by one step before the shaping of the next layer is started. In this manner, in the selective laser sintering, a target object is shaped in a powder-like material irradiated with a laser beam. According to the selective laser sintering, material properties (such as strength, hardness, toughness, and abrasion resistance) nearly equal to the material properties that the used material powder inherently possesses can be realized.

For the material powder used in the selective laser sintering, a metal powder and a ceramic material powder are commonly used. The metal powder is coated with water-soluble resin such as polyvinyl alcohol (PVA) to reduce or minimize oxidation of the material.

Direct metal laser sintering is different from selective laser sintering in which a carbon dioxide gas laser is mainly used in that an ytterbium laser is used. The ytterbium laser has advantages in that it has excellent output stability and it can stably maintain the same size. For the material powder, an uncoated metal powder made of a single material and a ceramic material powder are used.

Selective laser melting is the same as the selective laser sintering and the direct metal laser sintering in that irradiation with a laser beam is performed. In the selective laser melting, however, instead of being sintered, the material powder (a metal powder or a ceramic material powder) is melted and solidified to fabricate a shaped object. For the material, a metal powder that is the same as or similar to those described above is used. In performing shaping, Standard Triangulated Language (STL)-based 3D computer-aided design (CAD) data is cut into slices, and each layer is irradiated with a laser beam. An operation is repeated in which, upon solidification of one layer, the one layer is overlaid with metal powders that will serve as the next layer in the powder bed, and then the next layer is irradiated with a laser to be solidified. For the laser, as in the case of the direct metal sintering, a high-power ytterbium laser or the like is used. However, a higher power is obtained than in the direct metal sintering.

Electron beam melting is an additive method with an electron beam. The electron beam melting is a mechanism in which a metal powder is irradiated with an electron beam to be melted as in the case of the selective laser sintering. An electron beam emitted in high vacuum has a higher power and a higher speed than a laser beam, and this allows a precision metal part to be three-dimensionally printed accurately. Specifically, in the electron beam melting (EBM), the entire metal powder is heated to a constant temperature in producing a vacuum, and then the portion to be shaped is irradiated with an electron beam for high melting points. Here, an electron beam refers to a beam that is obtained by heating a filament in high vacuum and emitted by controlling emitted electrons with an electromagnetic coil. A ceramic material powder can also be used for the electron beam melting.

Unlike mechanisms in which a metal powder is irradiated with a laser, laser engineered net shaping is a method in which a metal powder is dropped from a nozzle into a molten pool, and then is sintered with a laser so that a layered body is formed. This method has advantages in that it allows smooth processing, provides a faster shaping speed, and can reduce the material cost to about half. A ceramic material powder can also be used for the laser engineered net shaping.

A procedure for fabricating the blade body 2 of the cutting implement 1 using a 3D printer will be described. First, 3D data that serves as an engineering drawing of the blade body 2 of the cutting implement 1 is prepared. Accordingly, 3D CAD software is utilized to perform modeling. For the 3D CAD software, a variety of commercially available products can be employed, and the 3D CAD software is not limited to a specific software.

In the present disclosure, 3D data are prepared for the base portion 21 that is a hollow body and the blade edge portion 22 that is a solid body, respectively. At this time, topology optimization software can also be used.

The 3D data created with 3D CAD software is converted into the 3D data format of the STL format. After the physical integrity of the STL data is checked in an STL verification tool, the target STL data is converted into actual data for the 3D printer to control the output. That is, the 3D data is cut into slices on a layer-by-layer basis, which are then converted into shaping tool path data (such as a G Code) for causing the 3D printer to operate. Conversion software is commonly referred to as slicer software.

Upon conversion of the STL data into the shaping tool path data, the tool path data is loaded into the 3D printer, and then shaping with the 3D printer is started. At this time, a support is designed and/or thermal stress is calculated as necessary to optimize the molding condition as appropriate.

In the present disclosure, the base portion 21 is made of a hollow body, and the blade edge portion 22 is made of a solid body. Thus, preferably, any one of the base portion 21 and the blade edge portion 22 is first shaped by the 3D printer, and then a control condition is changed before the other one is shaped.

The blade edge portion 22 preferably has a higher hardness than that of the base portion 21. To that end, the laser irradiation condition needs to be adjusted as appropriate. For example, a titanium carbide powder having a particle size of about from 2 to 5 μm may be added to a titanium alloy powder by about 0.1 to 0.3 mass % to add heterogeneous nucleation site particles and thereby form fine equiaxed crystals. In the SLM, without preheating, the cooling rate may be increased to obtain fine crystals. According to the LMD, cooling is fast, and thus fine crystals tend to be obtained. In the EBM and LMD, since columnar crystals extend in a direction parallel to the layering direction in a case where the liquid phase is transformed to the solid phase in a direction parallel to a layering direction, columnar crystals are formed with respect to the extended columnar crystals in the same as and/or similar to manner described above in a direction different from the direction parallel to the layering direction by 90 degrees, and these steps are repeatedly performed to form a layered body so that crystals grown in different directions overlap with each other. This can provide improved hardness. Depending on the cooling condition, a dense organizational structure between a metal and a ceramic or carbon can be developed to achieve high toughness and high hardness. After shaping the blade body 2, the material powder within the blade body 2 is discharged from the hole 4 of the handle portion 23. Note that at the time of shaping the base portion 21, the reinforcing wall 6 is simultaneously shaped.

A high toughness blade body 2 of the cutting implement 1 can be fabricated by controlling the organization. For example, adjusting the laser irradiation condition allows an effect that is the same as or similar to the effect of quenching to be exerted to increase the toughness of the blade body 2.

For the bonding together of the blade edge portion 22 and the base portion 21, since both are formed consecutively in the same shaping step, no step of bonding both together is necessary. That is, the blade edge portion 22 and the base portion 21 are integrally shaped. This allows high strength to be obtained even at the site considered to be the bonding portion between both.

The blade edge portion 22 can be formed by polishing the blade body 2 fabricated in this manner. When polishing the blade body 2, an abrasive such as alumina, silicon carbide, or diamond is preferably used to polish the blade body 2 at a secondary bevel angle from 20 to 40°. After polishing, the handle 3 is attached to the handle portion 23 of the blade body 2.

The obtained cutting implement 1 is lightweight because the base portion 21 is a hollow body, has excellent strength because the blade edge portion 22 is a solid body, and provides high sharpness.

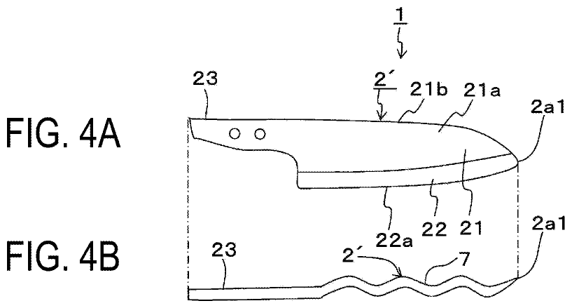

FIGS. 4A and 4B illustrate another embodiment of the present disclosure. As illustrated in FIG. 4B, a blade body 2′ has an undulating, serpentine shape, with an uneven portion 7 formed on both side faces 21a and 21a. This provides the cutting implement 1 with improved cutting and separating performance during the use. Apart from the above, this embodiment is the same as the embodiment described above. Thus, the identical components are assigned the identical reference signs, with description thereof being omitted.

Embodiments of the cutting implement according to the present disclosure have been described above. However, the present disclosure is by no means limited to the embodiments described above, and various modifications and enhancements can be made. For example, in the embodiments described above, the base portion 21 including the handle portion 23 and the blade edge portion 22 are fabricated with a 3D printer. However, the blade edge portion 22 that is a solid body may be fabricated in a different method, and, with a 3D printer, the base portion 21 including the handle portion 23 may be fabricated with a 3D printer and then be bonded to the blade edge portion 22.

### REFERENCE SIGNS

1 Cutting implement
2, 2′ Blade body
2a Cutting implement tip portion
2a1 Cutting implement tip
3 Handle
4 Hole
5 Space
6 Reinforcing wall
61 Vane
7 Uneven portion
21 Base portion
21a Side face
21b Spine
22 Blade edge portion
22a Blade edge ridge portion
22b Rear face portion of blade edge portion
23 Handle portion

1. A cutting implement comprising:
a blade body comprising a base portion and a blade edge portion disposed along an end portion of the base portion, wherein
the base portion is a hollow body,
the blade edge portion is a solid body, and
a reinforcing wall is provided inside the hollow body at at least a cutting implement tip portion.

2. The cutting implement according to claim 1, wherein
the base portion comprises both side faces and a spine,
the hollow body comprises a space formed by a rear face portion of the blade edge portion, the both side faces, and the spine, and
the reinforcing wall is provided between the both side faces.

3. The cutting implement according to claim 1, wherein
the base portion comprises a handle portion, and
a hole in communication with an internal space of the hollow body is formed in the handle portion.

4. The cutting implement according to claim 1, wherein the reinforcing wall is provided in a lattice shape.

5. The cutting implement according to claim 1, wherein
the base portion is formed from a first constituent material powder that is sintered or melted, and
the blade edge portion is formed from a second constituent material powder that is sintered or melted.

6. The cutting implement according to claim 5, wherein
the first constituent material powder and the second constituent material powder are a same powder or different powders, and
each of the first constituent material powder and the second constituent material powder is a metal powder selected from the group consisting of ferritic stainless steel, austenitic stainless steel, nickel-based alloy, titanium alloy, nickel-cobalt alloy, cobalt alloy, cobalt-chromium-tungsten alloy, and cobalt-chromium-molybdenum alloy.

7. The cutting implement according to claim 5, wherein
the first constituent material powder and the second constituent material powder are a same powder or different powders, and
each of the first constituent material powder and the second constituent material powder is a ceramic material powder selected from the group consisting of tungsten carbide, titanium carbide, vanadium carbide, and zirconium oxide as a main component.

8. The cutting implement according to claim 1, wherein a hardness of the blade edge portion is higher than a hardness of the base portion.
